(19) United States
(12) Patent Application Publication
(10) Pub. No.: US 2008/0071775 A1
(43) Pub. Date: Mar. 20, 2008

(54) System And Method For Ranking Items

(75) Inventor: William Gross, Pasadena, CA (US)

Correspondence Address: BRINKS HOFER GILSON & LIONE / YAHOO! OVERTURE, P.O. BOX 10395, CHICAGO, IL, 60610, US

(73) Assignee: Overture Services, Inc., Pasadena, CA (US)

(21) Appl. No.: 11/859,473

(22) Filed: Sep. 21, 2007

Related U.S. Application Data
(62) Division of application No. 09/765,270, filed on Jan. 18, 2001.

(51) Int. Cl. G06F 17/30

(52) U.S. Cl. 707/5; 707/E17.014

(57) ABSTRACT

A system and method for ranking items is disclosed. In one embodiment, the items constitute offerings offered by at least one on-line vendor. The system includes a ranking module that estimates the likelihood that a user will select the offerings and the likelihood that the user will purchase the items offered in the offerings. Based on this information, the ranking module calculates the expected revenue to be generated by the offerings. The ranking module then ranks the offerings relative to one another so as to increase income received by the system administrator.

### RELATED APPLICATION

The present application is a divisional of application Ser. No. 09/765,270, filed Jan. 18, 2001, pending, which is hereby incorporated herein by reference.

### FIELD OF INVENTION

This invention relates in general to systems and methods for ranking items, and relates more particularly to systems and methods for ranking offerings from on-line vendors.

### DESCRIPTION OF THE RELATED ART

Since the advent of the Internet, many commercial vendors have established websites that offer goods or services to consumers via the Internet. As a result, consumers have enjoyed unprecedented exposure to a wide variety of products and services available via the Internet. On the other hand, the amount of information about the goods and services available to consumers via the Internet can be overwhelming. Thus, it can be difficult for a consumer to effectively perform comparison shopping among a plurality of on-line vendors that offer a particular product or service in which the consumer is interested.

Accordingly, websites have been established to enable consumers to quickly and easily compare specific goods or services that are offered by a plurality of on-line vendors. These websites typically allow the consumer to browse through on-line listings of available goods and services and to identify a particular product or service in which the consumer is interested. Once the consumer has identified a particular product or service, the websites typically display to the consumer a list of referrals, or hyperlinks, to vendor websites that offer the product or service identified by the consumer. Historically, the referral lists displayed to consumers on these referring websites have been sorted based on a variety of factors, such as, for example, the cost of the product or service identified by the consumer or the names of the vendors that offer the identified product or service

### SUMMARY OF THE INVENTION

There is a need for a ranking scheme that adequately addresses the interests of the Internet vendors and of the entities that administer the referring websites. A system and method for ranking items is disclosed. In one embodiment, the items constitute offerings offered by at least one on-line vendor. The system includes a ranking module that estimates the likelihood that a user will select the offerings and the likelihood that the user will purchase the items offered in the offerings. Based on this information, the ranking module calculates the expected revenue to be generated by the offerings. The ranking module then ranks the offerings relative to one another so as to increase income received by the system administrator.

One embodiment of a method of ranking offerings offered by at least one on-line vendor comprises operating a ranking module affiliated with a first entity and ranking, with the ranking module, a first offering from an on-line vendor relative to a second offering from an on-line vendor so as to increase income received by the first entity.

Another embodiment of a method of ranking offerings offered by at least one on-line vendor comprises operating a ranking website affiliated with a first entity and estimating, with the ranking website, a selection likelihood that corresponds to the likelihood that a user will select a first offering from an on-line vendor. The method further comprises calculating, with the ranking website, an estimated selection revenue that corresponds to the revenue received by the first entity when the user selects the first offering and ranking, with the ranking website, the first offering relative to another offering so as to increase income received by the first entity.

Another embodiment of a method of ranking offerings offered by at least one on-line vendor comprises operating a ranking website affiliated with a first entity and estimating, with the ranking website, a purchase likelihood that corresponds to the likelihood that a user will purchase an item offered in a first offering from an on-line vendor. The method further comprises calculating, with the ranking website, an estimated purchase commission that corresponds to the commission received by the first entity when the user purchases the item offered in the first offering and ranking, with the ranking website, the first offering relative to another offering so as to increase income received by the first entity.

Another embodiment of a method of ranking hyperlinks to websites affiliated with at least one on-line vendor comprises operating a ranking website affiliated with a first entity, estimating, with the ranking website, a click likelihood that corresponds to the likelihood that a user will click on a first hyperlink to a website affiliated with an on-line vendor, and calculating, with the ranking website, an estimated click revenue that corresponds to the revenue received by the first entity when the user clicks on the first hyperlink. The method further comprises estimating, with the ranking website, a purchase likelihood that corresponds to the likelihood that the user will purchase an item offered on the website associated with the first hyperlink, calculating, with the ranking website, an estimated purchase commission that corresponds to the commission received by the first entity when the user purchases the item offered on the website associated with the first hyperlink, and ranking, with the ranking website, the fast hyperlink relative to another hyperlink so as to increase income received by the first entity.

Another embodiment of a method of operating a website that ranks referrals to at least one on-line vendor comprises operating a ranking module affiliated with a first entity, estimating a first click likelihood that corresponds to the likelihood that a user will click on a first referral to an on-line vendor, and calculating an estimated first click revenue that corresponds to the revenue received by the first entity when the user clicks on the first referral. The method further comprises estimating a first purchase likelihood that corresponds to the likelihood that the user will purchase an item mentioned in the first referral and calculating an estimated first purchase commission that corresponds to the commission received by the first entity when the user purchases the item mentioned in the first referral.

The method further comprises estimating a second click likelihood that corresponds to the likelihood that the user will click on a second referral to an on-line vendor and calculating an estimated second click revenue that corresponds to the revenue received by the first entity when the user clicks on the second referral. The method further comprises estimating a second purchase likelihood that corresponds to the likelihood that the user will purchase an item mentioned in the second referral and calculating an estimated second purchase commission that corresponds to the commission received by the first entity when the user purchases the item mentioned in the second referral. The method further comprises ranking with the ranking module the first referral relative to the second referral so as to increase income received by the first entity and displaying the first referral and the second referral on a website.

One embodiment of a system that ranks offerings offered by at least one on-line vendor comprises a first offering from an on-line vendor, a second offering from an on-line vendor, and a ranking module stored in a computer readable storage medium, wherein the ranking module is affiliated with a first entity, and wherein the ranking module ranks the first offering relative to the second offering so as to increase income received by the first entity.

Another embodiment of a system that ranks offerings offered by at least one on-line vendor comprises a first offering from an on-line vendor and a second offering from an on-line vendor. The system fitter comprises a ranking module stored in a computer readable storage medium, wherein the ranking module is affiliated with a first entity, and wherein the ranking module: estimates a first selection likelihood that corresponds to the likelihood that a user will select the first offering, calculates an estimated first selection revenue that corresponds to the revenue received by the first entity when the user selects the first offering, estimates a second selection likelihood that corresponds to the likelihood that the user will select the second offering, calculates an estimated second selection revenue that corresponds to the revenue received by the first entity when the user selects the second offering, and ranks the first offering relative to the second offering so as to increase income received by the first entity.

Another embodiment of a system that ranks offerings offered by at least one on-line vendor comprises a first offering from an on-line vendor and a second offering from an on-line vendor. The system further comprises a ranking module stored in a computer readable storage medium, wherein the ranking module is affiliated with a first entity, and wherein the ranking module: estimates a first purchase likelihood that corresponds to the likelihood that a user will purchase an item offered in the first offering and calculates an estimated first purchase commission that corresponds to the commission received by the first entity when the user purchases the item offered in the first offering. In addition, the ranking module estimates a second purchase likelihood that corresponds to the likelihood that the user will purchase an item offered in the second offering, calculates an estimated second purchase commission that corresponds to the commission received by the first entity when the user purchases the item offered in the second offering, and ranks the first offering relative to the second offering so as to increase income received by the first entity.

Another embodiment of a system that ranks offerings offered by at least one on-line vendor comprises a first offering from an on-line vendor and a second offering from an on-line vendor. The system further comprises a ranking module stored in a computer readable storage medium, wherein the ranking module is affiliated with a first entity, and wherein the ranking module: estimates a first selection likelihood that corresponds to the likelihood that a user will select the first offering and calculates an estimated fast selection revenue that corresponds to the revenue received by the first entity when the user selects the first offering. In addition, the ranking module estimates a first purchase likelihood that corresponds to the likelihood that the user will purchase an item offered in the first offering and calculates an estimated first purchase commission that corresponds to the commission ‘received by the first entity when the user purchases the item offered in the first offering.

Furthermore, the ranking module estimates a second selection likelihood that corresponds to the likelihood that the user will select the second offering and calculates an estimated second selection revenue that corresponds to the revenue received by the first entity when the user selects the second offering. Moreover, the ranking module estimates a second purchase likelihood that corresponds to the likelihood that the user will purchase an item offered in the second offering, calculates an estimated second purchase commission that corresponds to the commission received by the first entity when the user purchases the item offered in the second offering, and ranks the first offering relative to the second offering so as to increase income received by the first entity.

For purposes of summarizing the invention, certain aspects, advantages and novel features of the invention have been described herein. It is to be understood that not necessarily all such advantages may be achieved in accordance with any particular embodiment of the invention. Thus, the invention may be embodied or carried out in a manner that achieves or optimizes one advantage or group of advantages as taught herein without necessarily achieving other advantages as may be taught or suggested herein.

### BRIEF DESCRIPTION OF THE DRAWINGS

FIG. 1 is a system-level block diagram illustrating the overall network architecture of a system in accordance with one embodiment of the present invention.

FIG. 2 is a block diagram illustrating the system architecture of one embodiment of the referral computer.

FIGS. 3A-3P illustrate exemplary tables that may be stored on the referral computer in one embodiment of the invention.

FIG. 4 illustrates an example Web page that allows consumers to search for particular products or services in accordance with one embodiment of the invention.

FIG. 5 illustrates an example Web page that displays a list of offerings from on-line vendors in accordance with one embodiment of the invention.

FIG. 6 is a flow chart illustrating a method for ranking of a plurality of items in accordance with one embodiment of the present invention.

FIG. 7 is a flow chart illustrating a method for calculating the expected revenue for a particular item in accordance with one embodiment of the present invention.

### DETAILED DESCRIPTION OF THE PREFERRED EMBODIMENT

The present invention relates to a system and method for ranking items. In one embodiment, the ranked items are offerings offered by on-line vendors. The offerings are displayed to consumers, and when a consumer selects an offering or purchases a product or service as a result of selecting an offering, the system administrator preferably receives income from the on-line vendors. The system calculates the expected revenue to be generated by each offering by determining the amount that will be received if the user selects an offering and ultimately purchases a product, and by estimating the likelihood that the user will take these actions. The offerings are then ranked based on their relative expected revenues, and they are displayed to the user such that the user is most likely to select the offering which the system has predicted will generate the most income for the system administrator.

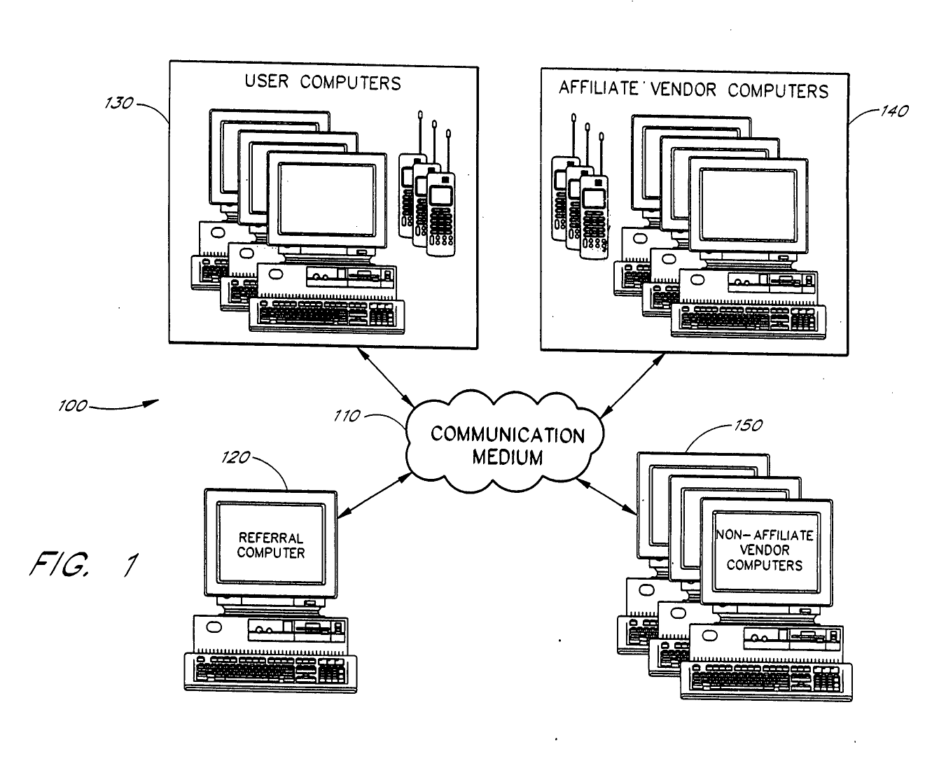

FIG. 1 is a system-level block diagram illustrating the overall network architecture of a system 100 in accordance with one embodiment of the present invention. The system 100 comprises a communication medium 110, which is coupled to a referral computer 120, to a plurality of user computers 130, to a plurality of affiliate vendor computers 140, and to a plurality of non-affiliate vendor computers 150.

The communication medium 110 may advantageously facilitate the transfer of electronic content. The communication medium 110 may comprise, for example, local area networks (LANs), wide area networks (WANs), public internets, private internets, secure internets, private networks, public networks, value-added networks, wireless data transmission networks, cellular telephone networks (including analog and digital systems), Public Switched Telephone Networks (PSTNs), Integrated Services Digital Networks (ISDNs), satellite communications networks (including, for example, the Iridium system), interactive television networks, two-way cable networks, interactive kiosk networks, and the like.

In a preferred embodiment, the communication medium 110 comprises the Internet. The Internet is a global network connecting millions of computers. The structure of the Internet, which is well known to those of ordinary skill in the art, is a global network of computer networks utilizing a simple standard common addressing system and communications protocol called Transmission Control Protocol/Internet Protocol (TCP/IP). The connections between different networks are called “gateways,” and the gateways serve to transfer electronic data worldwide.

One part of the Internet is the World Wide Web (WWW). The WWW is generally used to refer to both (1) a distributed collection of interlinked, user-viewable hypertext documents (commonly referred to as “web documents” or “electronic pages” or “home pages”) that are accessible via the Internet, and (2) the client and server software components which provide user access to such documents using standardized Internet protocols. The web documents are encoded using Hypertext Markup Language (HTML) and the primary standard protocol for allowing applications to locate and acquire web documents is the Hypertext Transfer Protocol (HTTP). However, the team WWW is intended to encompass future markup languages and transport protocols which may be used in place of, or in addition to, HTML and HTTP.

The WWW contains different computers which store electronic pages, such as HTML documents, capable of displaying graphical and textual information. The computers that provide content on the WWW are generally referred to as “websites.” A website is defined by an Internet address, or Universal Resource Locator (URL), and the URL has an associated electronic page. Generally, an electronic page may advantageously be a document that organizes the presentation of text, graphical images, audio, and video.

Those of ordinary skill in the art will understand that the referral computer 120, the user computers 130, the affiliate vendor computers 140, and the non-affiliate vendor computers 150 may comprise a wide variety of devices that are controlled by a microprocessor or a processor and that permit access to the communication medium 110, including but not limited to personal computers, workstations, servers, mini computers, main-frame computers, laptop computers, mobile computers, networks of individual computers, set top boxes for televisions, interactive televisions, interactive kiosks, or combinations thereof. Furthermore, the user computers 130 and the affiliate vendor computers 140 may also comprise a variety of portable computers, such as, for example, cellular telephones, interactive wireless communications devices, palm top computers, hand held computers, personal digital assistants (PDAs), and the like.

Those of ordinary skill in the art will also understand that the computers 120, 130, 140, 150 may further comprise input devices, such as, for example, a keyboard or a mouse, and output devices, such as, for example, a monitor or a speaker. Moreover, the computers 120, 130, 140, 150 may serve as clients, servers, or a combination thereof.

The computers 120, 130, 140, 150 may be uniprocessor or multiprocessor machines. Additionally, the computers 120, 130, 140, 150 may include an addressable storage medium or computer accessible medium, such as random access memory (RAM), erasable programmable read-only memory (EPROM), electronically erasable programmable read-only memory (EEPROM), hard disks, floppy disks, laser disk players, digital video devices, compact disks, video tapes, audio tapes, magnetic recording tracks, electronic networks, and other techniques to transmit or store data.

The computers 120, 130, 140, 150 are preferably equipped with network communication devices, such as, for example, a network interface card, a modem, or another network communication device suitable for connecting to the communication medium 110. Furthermore, the computers 120, 130, 140, 150 preferably execute an appropriate operating system such as Unix, Microsoft® Windows® 3.1, Microsoft® Windows® 95, Microsoft Windows® 98, Microsoft Windows® NT, Apple® MacOS®, or IBM OS/2®. As is conventional, the appropriate operating system includes a communications protocol implementation, which handles all incoming and outgoing message traffic passed over the communication medium 110. In other embodiments, while the operating system may differ depending on the type of computer, the operating system will continue to provide the appropriate communications protocols necessary to establish communication links with the communication medium 110.

Several modules will be described hereafter. The modules may advantageously be configured to reside on an addressable storage medium and configured to execute on one or more processors. The modules may include, but are not limited to, software or hardware components that perform certain tasks. Thus, a module may include, for example, object-oriented software components, class components, processes methods, functions, attributes, procedures, subroutines, segments of program code, drivers, firmware, microcode, circuitry, data, databases, data structures, tables, arrays, and variables.

In one embodiment, the referral computer 120 includes a database containing information regarding a variety of products and services offered by numerous on-line vendors. For example, the database may contain information such as product pricing information or product availability information. This information is gathered and maintained by a referral computer administrator. In one embodiment, some of the vendors accessible through the referral computer 120 are affiliated with the referral computer administrator, while other vendors accessible through the referral computer 120 are not affiliated with the referral computer administrator.

In one embodiment, a vendor may complete a registration process with the referral computer administrator, as described in more detail below, to become an affiliate vendor. After completing the registration process, the affiliate vendors can advantageously use the affiliate vendor computers 140 to access the referral computer 120 through the communication medium 110. Once a particular affiliate vendor gains access to the referral computer 120, it can update the information in the database regarding its products and services directly. The affiliate vendors can perform these updates periodically so that the information contained in the database advantageously remains current.

In one embodiment, affiliate vendors can enable the referral computer 120 to periodically browse, or “crawl,” their websites, which are hosted at the affiliate vendor computers 140, to obtain current information automatically regarding their products and services. Thus, the information contained in the database regarding the affiliate vendor's products and services can advantageously remain current without requiring intervention by the affiliate vendor.

In one embodiment, the referral computer administrator collects information about the products and services offered by non-affiliate vendors by accessing the non-affiliate vendor computers 150 through the communication medium 110. For example, as described above, the referral computer 120 can be enabled to periodically crawl the non-affiliate vendor websites, which are hosted at the non-affiliate vendor computers 150, to gather current information about the products and services offered by a particular non-affiliate vendor. Once the referral computer 120 has gathered this information, it updates the database accordingly so that the information contained in the database advantageously remains current.

The user computers 130 are used by consumers to access the referral computer 120 through the communication medium 110. Consumers can advantageously browse through the information contained in the database to identify a particular product or service in which they are interested. Once a consumer has identified a particular product or service, the referral computer 120 displays to the consumer a list of offerings from a plurality of on-line vendors that offer the product or service identified by the consumer. In one embodiment, the list of offerings is displayed to the consumer as referrals, or hyperlinks, to the websites of the on-line vendors that offer the product or service identified by the consumer.

The referral computer administrator preferably derives revenue from the affiliate vendors and from the non-affiliate vendors by referring consumers to the vendors' websites. For example, in one embodiment, the referral computer administrator receives a predetermined fee from a vendor when events such as the following occur: (1) a hyperlink to the vendor's website is displayed to a consumer, (2) a consumer clicks on a hyperlink to the vendor's website, or (3) a consumer ultimately purchases a of a product or service from the vendor after clicking on a hyperlink to the vendor's website.

As described in more detail below, the affiliate vendors can adjust these predetermined fees periodically by accessing and updating the database stored at the referral computer 120. The affiliate vendors can advantageously set one fee schedule for a large group of products or services, or alternatively, they can set different fee schedules for individual products or services.

In one embodiment, the non-affiliate vendors are willing to pay fees to any party, such as the referral computer administrator, that refers customers to the non-affiliate vendors. Some non-affiliate vendors publicize the fees that they are willing to pay to any referring party. Thus, the referral computer administrator can advantageously predict the revenue that will be received for referring customers to these non-affiliate vendors.

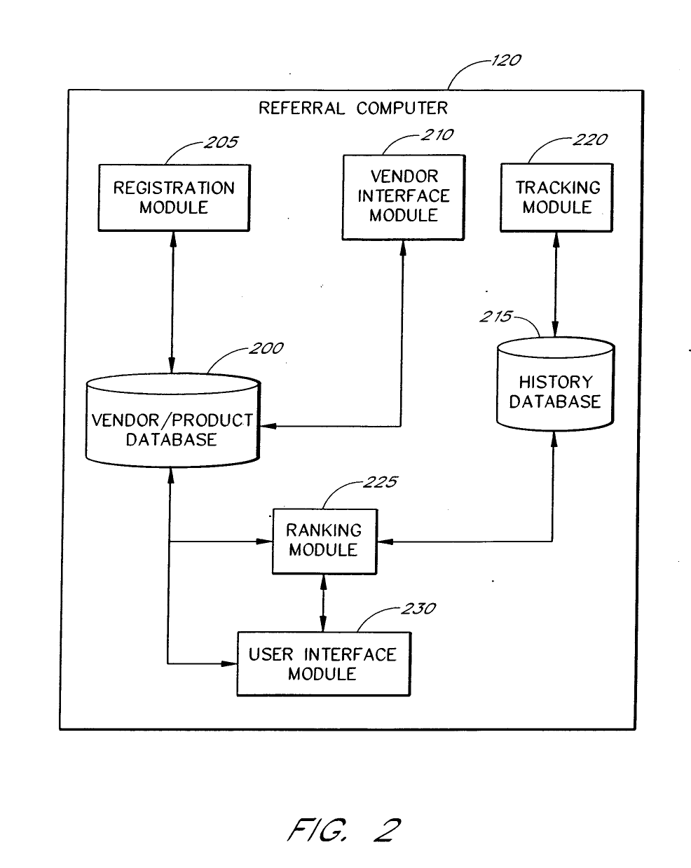

FIG. 2 is a block diagram illustrating the system architecture of one embodiment of the referral computer 120. In the illustrated embodiment, the referral computer 120 comprises a vendor/product database 200 coupled to a registration module 205 and to a vendor interface module 210. The referral computer 120 further comprises a history database 215 coupled to a tracking module 220. The vendor/product database 200 is also coupled to a ranking module 225 and to a user interface module 230. The history database 215 is also coupled to the ranking module 225. In addition, the user interface module 230 is coupled to the ranking module 225.

As discussed above, in one embodiment, on-line vendors can use the registration module 205 to complete a registration process and become affiliated with the referral computer administrator. During the registration process, the vendor provides certain information to the referral computer administrator, such as, for example, information regarding a contact person associated with the vendor. This information is preferably stored in the vendor/product database 200.

Once a particular on-line vendor has become an affiliate vendor, it can access the referral computer 120 using the vendor interface module 210. Therefore, as discussed above, the affiliate vendor can advantageously update the information in the vendor/product database 200 regarding its products and services directly. The vendor interface module 210 preferably performs a verification procedure to confirm the identity of a party seeking access to the vendor/product database 200 before granting access thereto For example, the vendor interface module 210 may request a user name and password from a party seeking access to the vendor/product database 200.

In one embodiment, the tracking module 220 gathers information about user activity and stores this information in the history database 215. For example, the tracking module 220 may gather information about the selection patterns of users among various on-line vendors that offer a particular product or service. In addition, the tracking module 220 may gather information about the buying patterns of users among various on-line vendors.

In one embodiment, consumers use the user interface module 230 to access the vendor/product database 200 stored on the referral computer 120. As discussed above, consumers can advantageously browse through the information contained in the vendor/product database 200 to identify a particular product or service in which they are interested. Once a consumer has identified a particular product or service, the referral computer 120 determines which vendors offer the selected product or service. Once the referral computer 120 makes this determination, it generates a list of offerings from the vendors that offer the product or service identified by the consumer.

The ranking module 225 sorts the list of offerings generated by the referral computer 120. In one embodiment, the offerings are ranked based on the expected revenue for the referral computer administrator generated by each offering. The ranking module 225 can utilize the information contained in the vendor/product database 200 and in the history database 215 to determine the expected revenue generated by each offering.

For example, a consumer browses through the vendor/product database 200 and selects Product 1, which is offered by Vendor A and Vendor B. Based on the information contained in the vendor/product database 200, the referral computer 120 determines that the fee that the referral computer administrator will receive from Vendor A if the consumer selects Vendor A's offering and ultimately purchases the product from Vendor A is slightly higher than the fee that the referral computer administrator will receive from Vendor B if the consumer selects Vendor B's offering and ultimately purchases the product from Vendor B.

Based on the information regarding past user activity contained in the history database 215, however, the referral computer 120 determines that the likelihood that the consumer will select Vendor B's offering and ultimately purchase the product from Vendor B is much greater than the likelihood that the consumer is will select Vendor A's offering and ultimately purchase the product from Vendor A. Thus, by utilizing the information contained in both the vendor/product database 200 and in the history database 215, the referral computer 120 determines that the expected revenue to be received by the referral computer administrator from Vendor B's offering exceeds the expected revenue to be received from Vendor A's offering. Accordingly, the referral computer 120 determines that Vendor B's offering should be ranked before Vendor A's offering in the list of offerings for Product 1 that is displayed to the consumer.

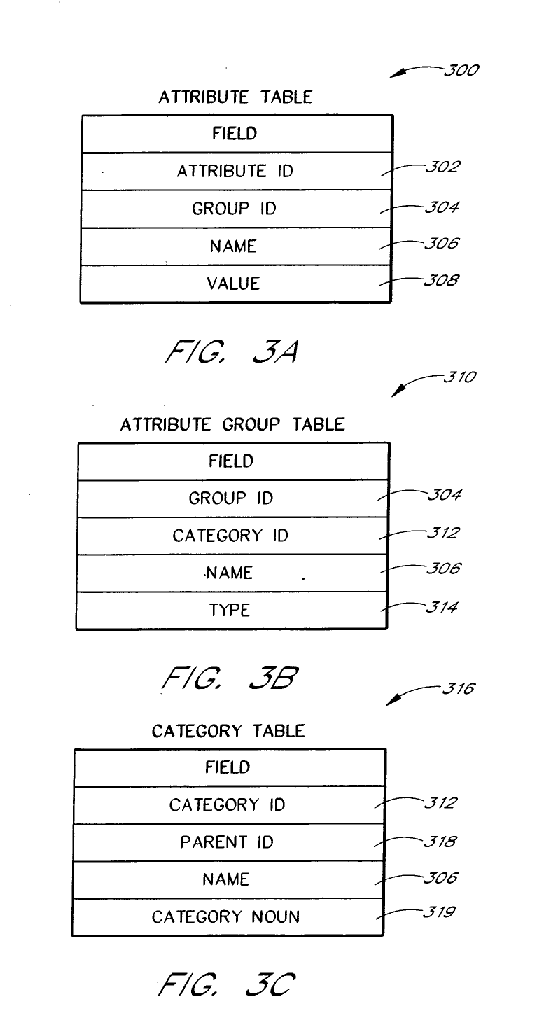

FIGS. 3A-3P illustrate exemplary tables that may be stored in the referral computer 120 in one embodiment of the invention. In general, the tables illustrated in FIGS. 3A-3P provide information regarding the relationships among the data stored in the referral computer 120. Those of ordinary skill in the art will understand that while the tables illustrated in FIGS. 3A-3P demonstrate one possible organizational scheme for the data stored in the referral computer 120, countless other organizational schemes are possible.

FIG. 3A illustrates an Attribute Table 300 which, in one embodiment, comprises an Attribute ID field 302, a Group ID field 304, a Name field 306, and a Value field 308. In one embodiment, the Attribute ID field 302 contains text variables storing identification information regarding product attributes. The Group ID field 304 contains text variables storing identification information regarding product groups. The Name field 306 contains text variables storing data regarding product names. The Value field 308 contains numerical variables storing data regarding attribute values. In general, the Attribute Table 300 allows attributes, such as size or color, to be assigned to a particular product or to a group of products.

FIG. 3B illustrates an Attribute Group Table 310 which, in one embodiment, comprises the Group ID field 304, a Category ID field 312, the Name field 306, and a Type field 314. In one embodiment, as discussed above, the Group ID field 304 contains text variables storing identification information regarding product groups. The Category ID field 312 contains text variables storing identification information regarding product categories. As discussed above, the Name field 306 contains text variables storing information regarding product names. The Type field 314 contains text variables storing information regarding product types.

A Category is a category of products, e.g., “cars” or “electronics.” An Attribute Group is a group of attributes that apply to a particular category of products and whose controls are displayed together to the user. For example, the category “televisions” might have the attributes “27 inches” and “20 inches” belonging to the same attribute group “diagonal size.” Thus, if a user desires to search for televisions having either of these attributes, the search results could be shown together, because they are different values of the same measurement or in general are otherwise conceptually related.

FIG. 3C illustrates a Category Table 316 which, in one embodiment, comprises the Category ID field 312, a Parent ID field 318, the Name field 306, and a Category Noun field 319. In one embodiment, as discussed above, the Category ID field 312 contains text variables storing identification information regarding product categories. The Parent ID field 318 contains text variables storing identification information regarding parent categories. As discussed above, the Name field 306 contains text variables storing information regarding product names. Furthermore, the Category Noun field 319 contains text variables.

In particular, the Category Noun field 319 contains a generic, singular name for items in the corresponding category that can be used in messages displayed to the user. For example, the Category Noun entry for the Category “televisions” might be “television” (“your search returned 1 television”) and the Category Noun entry for the Category “electronics” might be “electronics item” (“your search returned I electronics item”). In general, the Category Table 316 provides information regarding the hierarchical relationship among the categories of products or services For example, if Category 1 (e.g., Televisions) is a subcategory of Category 2 (e.g., Electronics), then the Category Table 316 would include an entry in which the ID for Category I is stored in the Category ID field 312 and the ID for Category 2 is stored in the Parent ID field 318.

FIG. 3D illustrates a Category Bid Table 318 which, in one embodiment, comprises a Vendor ID field 320, the Category ID field 312, a Click Bid field 322, a Purchase Bid field 324, and a Purchase Fraction field 326. In one embodiment, the Vendor ID field 320 contains text variables storing identification information regarding vendors. As discussed above, the Category ID field 312 contains text variables storing identification information regarding product categories. The Click Bid field 322 contains numerical variables storing data regarding the amount that a particular vendor will pay to the referral computer administrator in the event that a consumer clicks on a hyperlink to the vendor's website.

The Purchase Bid field 324 contains numerical variables storing data regarding the amount, as a flat fee, that a particular vendor will pay to the referral computer administrator in the event that a consumer purchases a product or service at the vendor's website. The Purchase Fraction field 326 contains numerical variables storing data regarding the amount, as a percentage of the price of a product or service, that a particular vendor will pay to the referral computer administrator in the event that a consumer purchases the product or service at the vendor's website.

In general, the Category Bid Table 318 stores information regarding the fees that vendors are willing to pay to the referral computer administrator in connection with particular categories of products or services. For example, Vendor A is willing to pay the referral computer administrator a $0.10 referral fee every time a consumer selects an offering from Vendor A for a product in Category 1. Furthermore, every time a consumer purchases a product in Category 1 from Vendor A, the vendor is willing to pay the referral computer administrator a 51.00 commission fee plus 5% of the purchase price.

Based on the information provided in this example, the Category Bid Table 318 includes an entry in which the ID for Vendor A is stored in the Vendor ID field 320 and the ID for Category 1 is stored in the Category ID field 312. Moreover, the Click Bid field 322 for the entry has a value of 0.10 (or $0.10), the Purchase Bid field 324 has a value of 1.00 (or $1.00), and the Purchase Fraction field 326 has a value of 0.05 (or 5%).

In one embodiment, as discussed above in connection with FIG. 1, Vendor A is an affiliate vendor and provides this information to the referral computer administrator using the vendor interface module 210 of the referral computer 120. In another embodiment, as discussed above, Vendor A is a non-affiliate vendor and disseminates this information publicly. In this embodiment, the referral computer administrator can gather the information from publicly available sources and can manually enter the information into the Category Bid Table 318. Alternatively, the information can be gathered and automatically entered into the Category Bid Table 318 based on past transactions between the referral computer administrator and the non-affiliate vendor.

FIG. 3E illustrates a Category Synonym Table 328 which, in one embodiment, comprises the Category ID field 312 and a Synonym field 330. In one embodiment, as discussed above, the Category ID field 312 contains text variables storing identification information regarding product categories. The Synonym field 330 contains text variables storing information regarding synonyms for product category names.

In general, the Category Synonym Table 328 enables the referral computer 120 to recognize a particular category by a variety of different names. For example, if the products in Category I include motor vehicles, a consumer may try to access the category using terms such as car, truck, automobile, or the like. Accordingly, the Category Synonym Table 328 would include a plurality of entries in which the ID for Category I is stored in the Category ID field 312 and a synonym for the category name, such as car, truck, or automobile, is stored in the Synonym field 330.

FIG. 3F illustrates a Denormal Table 332 which, in one embodiment, comprises a Product ID field 334, the Vendor ID field 320, a Price field 336, an Availability field 338, a Start Time field 340, an End Time field 342, a Click URL field 344, a Click Likelihood field 346, a Buy Likelihood field 348, a Rebate Amount field 347, a Rebate Type field 349, a Manufacturer ID field 350, the Name field 306, and an Expected Revenue field 352. In one embodiment, the Product ID field 334 contains text variables storing identification information regarding products. As discussed above; the Vendor ID field 320 contains text variables storing identification information regarding vendors.

The Price field 336 contains numerical variables storing data regarding the prices of products or services. The Availability field 338 contains text variables storing information regarding the availability of products or services. The Start Time field 340 contains numerical variables storing data regarding the start times of offers for particular products or services. The End Time field 342 contains numerical variables storing data regarding the end times of offers for particular products or services. The Click URL field 344 contains text variables storing information regarding the URLs of websites relating to particular offers.

The Click Likelihood, field 346 contains numerical variables storing data regarding the likelihood of a consumer to click on a particular hyperlink to a vendor's website. The Buy Likelihood field 348 contains numerical variables storing data regarding the likelihood that a consumer will complete a purchase after clicking on a particular hyperlink. In one embodiment, the referral computer 120 determines these likelihoods by referring to data regarding past user activity stored in the history database 215. As discussed above in connection with FIG. 2, this data is gathered and stored by the tracking module 220 of the referral computer 120. In one embodiment, the values stored in the Click Likelihood field 346 and the Buy Likelihood field 348 are updated often, as data regarding user activity is collected and updated by the tracking module 220.

For example, based on past user activity, the tracking module 220 of the referral computer 120 determines that Offering I has been displayed 100 times, and that it has been selected by users 50 times. In addition, the tracking module 220 determines that of the 50 times that Offering 1 has been selected, 10 purchases have occurred. Thus, the Denormal Table 332 includes an entry in which the Click Likelihood field 346 has a value of 0.50 (or 500/6) and the Buy Likelihood field 348 has a value of 0.10 (or 10%).

In some embodiments, the tracking module 220 refers to the entire user history associated with an offering to determine the click likelihood and the buy likelihood for the offering. In some embodiments, the tracking module 220 refers only to more recent user activity, such as, for example, user activity within, a 30-day, 60-day, or 90-day time period to determine the click likelihood and the buy likelihood for a particular offering. Those of ordinary skill in the art will understand that the tracking module 220 may utilize user history data occurring within a variety of different time periods to determine the click likelihood and the buy likelihood for a particular offering.

The Rebate Amount field 347 contains numerical variables storing data regarding the rebate amounts being offered for particular products or services. The Rebate Type field 349 contains text variables storing data regarding the types of rebates being offered for particular products or services. The Manufacturer ID field 350 contains text variables storing identification information regarding product manufacturers. As discussed above, the Name field 306 contains text variables storing information regarding product names.

The Expected Revenue field 352 contains numerical variables storing data regarding the expected revenue to be received by the referral computer administrator as a result of a particular offering. In general, the Denormal Table 332 provides information regarding the relationship between the click likelihood and the purchase likelihood for a particular offering and the expected revenue to be generated by the offering. As discussed in more detail below, the ranking module 225 of the referral computer 120 determines the expected revenue generated by each offering utilizing, for example, the data stored in the Click Bid field 322, in the Purchase Bid field 324, in the Purchase Fraction bid 326, in the Click Likelihood field 346, and in the Buy Likelihood field 348.

FIG. 3G illustrates a Manufacturer Table 354 which, in one embodiment, comprises the Manufacturer ID field 350 and the Name field 306. In one embodiment, as discussed above, the Manufacturer ID field 350, contains text variables storing identification information regarding product manufacturers. Furthermore, as discussed above, the Name field 306 contains text variables storing information regarding product names. In general, the Manufacturer Table 354 provides information regarding the manufacturers for products stored in the vendor/product database 200.

FIG. 3H illustrates an Offer Table 356 which, in one embodiment, comprises the Product ID field 334, the Vendor ID field 320, the Price field 336, the Availability field 338, the Start Time field 340, the End Time field 342, the Click URL field 344, the Click Likelihood field 346, the Buy Likelihood field 348, the Rebate Amount field 347, and the Rebate Type field 349. In one embodiment, as discussed above, the Product ID field 334 contains text variables storing identification information regarding products. The Vendor ID field 320 contains text variables storing identification information regarding vendors.

The Price field 336 contains numerical variables storing data regarding the prices of products or services. The Availability field 338 contains text variables storing information regarding the availability of products or services. The Start Time field 340 contains numerical variables storing data regarding the start times of offer; for particular products or services. The End Time field 342 contains numerical variables storing data regarding the end times of offers for particular products or services.

The Click URL field 344 contains text variables storing information regarding the URLs of websites relating to particular offers. The Click Likelihood field 346 contains numerical variables storing data regarding the likelihood of a consumer to click on a particular hyperlink to a vendor's website. The Buy Likelihood field 348 contains numerical variables storing data regarding the likelihood that a consumer will complete a purchase after clicking on a particular hyperlink. The Rebate Amount field 347 contains numerical variables storing data regarding the rebate amounts being offered for particular products or services. The Rebate Type field 349 contains text variables storing data regarding the types of rebates being offered for particular products or services.

In general, the Offer Table 356 provides information regarding the offerings stored in the vendor/product database 200. For example, Vendor A offers Product I for $50 from Dec. 1, 2000 through Dec. 24, 2000. The Offer Table 356 includes an entry in which the ID for Product 1 is stored in the Product ID field 334, the ID for Vendor A is stored in the Vendor ID field 320, and the Price field 336 has a value of 50 (or $50). The Availability field 338 is frequently updated to indicate the number of items currently in stock. The Start Time field 340 has a value of Dec. 1, 2000, and the End Time field 342 has a value of Dec. 24, 2000.

FIG. 31 illustrates a Product Table 358 which, in one embodiment, comprises the Product ID field 334, the Manufacturer ID field 350, a Model Number field 360, the Name field 306, and an Image URL field 364. In one embodiment, as discussed above, the Product ID field 334 contains text variables storing identification information regarding products. The Manufacturer ID field 350 contains text variables storing identification information regarding product manufacturers. The Model Number field 360 contains text variables storing information regarding product model numbers. As discussed above, the Name field 306 contains text variables storing information regarding product names. The Image URL field 364 contains text variables storing information regarding the URLs of websites containing product images. In general, the Product Table 358 provides information regarding the products stored in the vendor/product database 200.

FIG. 3J illustrates a Product Attribute Table 366 which, in one embodiment, comprises the Product ID field 334 and the Attribute ID field 302. In one embodiment, as discussed above, the Product ID field 334 contains text variables storing identification information regarding products. The Attribute ID field 302 contains text variables storing identification information regarding product attributes. In general, the Product Attribute Table 366 provides information regarding the attributes of the products stored in the vendor/product database 200.

FIG. 3K illustrates a Product Bid Table 368 which, in one embodiment, comprises the Vendor ID field 320, the Product ID field 334, the Click Bid field 322, the Purchase Bid field 324, the Purchase Fraction field 326, and the Category ID field 312. In one embodiment, as discussed above, the Vendor ID field 320 contains text variables storing identification information regarding vendors. The Product ID field 334 contains text variables storing identification information regarding products. The Click Bid field 322 contains numerical variables storing data regarding the amount that a particular vendor will pay to the referral computer administrator in the event that a consumer clicks on a hyperlink to the vendor's website.

The Purchase Bid field 324 contains numerical variables storing data regarding the amount, as a flat fee, that a particular vendor will pay to the referral computer administrator in the event that a consumer purchases a product or service at the vendor's website. The Purchase Fraction field 326 contains numerical variables storing data regarding the amount, as a percentage of the price of a product or service that a particular vendor will pay to the referral computer administrator in the event that a consumer purchases the product or service at the vendor's website. The Category ID field 312 contains text variables storing identification information regarding product categories.

In general, the Product Bid Table 318 stores information regarding the fees that vendors are willing to pay to the referral computer administrator in connection with particular products or services. For example, Vendor A is willing to pay the referral computer administrator a $0.10 referral fee every time a consumer selects an offering from Vendor A for Product 1. Furthermore, every time a consumer purchases a Product 1 from Vendor A, the vendor is willing to pay the referral computer administrator a $1.00 commission fee plus 5% of the purchase price.

Based on the information provided in this example, the Product Bid Table 368 includes an entry in which the ID for Vendor A is stored in the Vendor ID field 320 and the ID for Product 1 is stored in the Product ID field 334. Moreover, the Click Bid field 322 for the entry has a value of 0.10 (or $0.10), the Purchase Bid field 324 has a value of 1.00 (or $1.00), and the Purchase Fraction field 326 has a value of 0.05 (or 5%).

In one embodiment, as discussed above, Vendor A is an affiliate vendor and provides this information to the referral computer administrator using the vendor interface module 210 of the referral computer 120. In another embodiment, as discussed above, Vendor A is a non-affiliate vendor and disseminates this information publicly. In this embodiment, the referral computer administrator can gather the information from a publicly available source and can manually enter the information into the Product Bid Table 318. Alternatively, the information can be gathered and automatically entered into the Product Bid Table 318 based on past transactions between the referral computer administrator and the non-affiliate vendor.

FIG. 3L illustrates a Product Category Table 376 which, in one embodiment, comprises the Product ID field 334 and the Category ID field 312. In one embodiment, as discussed above, the Product ID field 334 contains text variables storing identification information regarding products. The Category ID field 312 contains text variables storing identification information regarding product categories. In general, the Product Category Table 376 provides information regarding the relationship between the products and categories stored in the vendor/product database 200.

FIG. 3M illustrates a Product Description Table 378 which, in one embodiment, comprises the Product ID field 334 and a Description field 380. In one embodiment, as discussed above, the Product ID field 334 contains text variables storing identification information regarding products. The Description field 380 contains text variables storing information regarding product descriptions. In general, the Product Description Table 378 stores information regarding the descriptions for the products stored in the vendor/product database 200.

FIG. 3N illustrates a Product Keyword Table 382 which, in one embodiment, comprises the Product ID field 334 and a Keyword field 384. In one embodiment, as discussed above, the Product ID field 334 contains text variables storing identification information regarding products. The Keyword field 384 contains text variables storing information regarding product keywords.

In general, the Product Keyword Table 382 enables a consumer to access a particular product using a variety of different keywords. For example, if Product I is an automobile, a consumer may try to access the product using terms such as car, automobile, sedan, or the like. Accordingly, the Product Keyword Table 328 would include a plurality of entries in which the ID for Product 1 is stored in the Product ID field 334 and a keyword for the product, such as car, automobile, or sedan, is stored in the Keyword field 384.

FIG. 30 illustrates a Vendor Table 386 which in one embodiment, comprises the Vendor ID field 320, the Name field 306, a URL field 388, a Logo Image URL field 390, and an Account ID field 402. In one embodiment, as discussed above, the Vendor ID field 320 contains text variables storing identification information regarding vendors. The Name field 306 contains text variables storing information regarding product names.

The URL field 388 contains text variables storing information regarding the URLs of vendor websites. The Logo Image URL field 390 contains text variables storing information regarding the URLs of websites containing vendor logo images. As discussed above, the Account ID field 402 contains text variables storing identification information regarding vendor accounts. In general, the Vendor Table 386 stores information regarding the vendors offering products stored in the vendor/product database 200.

FIG. 3P illustrates a Vendor Account Table 404 which, in one embodiment, comprises the Account ID field 402, a Contact Last Name field 406, a Contact First Name field 408, a Contact Middle Initial field 410, a Contact Phone field 412, a Contact Fax field 414, a Contact E-Mail field 416, a Contact Address 1 field 418, a Contact Address 2 field 420, a Contact City field 422, a Contact State field 424, a Contact Zip field 426, a Contact Country field 428, a User Name field 430, a Password field 432, a Billing Last Name field 434, a Billing First Name field 436, a Billing Middle Initial field 438, a Billing Phone field 440, a Billing Address I field 444, a Billing Address 2 field 446, a Billing City field 448, a Billing State field 450, a Billing Zip field 452, a Billing Country field 454, and a Billing E-Mail field 456. In one embodiment, as discussed above; the Account ID field 402 contains text variables storing identification information regarding vendor accounts.

The Contact Last Name field 406, the Contact First Name field 408, and the Contact Middle Initial field 410 contain text variables storing identification information for contact persons affiliated with particular vendors. The Contact Phone field 412, the Contact Fax field 414, the Contact E-Mail field 416, the Contact Address 1 field 418, the Contact Address 2 field 420, the Contact City field 422, the Contact State field 424, the Contact Zip field 426, and the Contact Country field 428 contain text variables storing contact information for these contact persons. The User Name field 430 and the Password field 432 contain text variables storing security information for particular vendor accounts. The Billing Last Name field 434, the Billing First Name field 436, and the Billing Middle Initial field 438 contain text variables storing identification information for billing contact persons affiliated with particular vendors. The Billing Phone field 440, the Billing Address 1 field 444, the Billing Address 2 field 446, the Billing City field 448, the Billing State field 450, the Billing Zip field 452, the Billing Country field 454, and the Billing E-Mail field 456 contain text variables storing contact information for these billing contact persons.

In general, the Vendor Account Table 404 stores account information regarding the vendors offering products stored in the vendor/product database 200. In one embodiment, an affiliate vendor provides the information stored in the Vendor Account Table 404 to the referral computer administrator using the vendor interface module 210 of the referral computer 120. In one embodiment, the referral computer administrator gathers information regarding non-affiliate vendors from publicly available sources and manually enters the information into the Vendor Account Table 404.

FIG. 3Q illustrates a Spread Request Table 404 which, in one embodiment, comprises the Account ID field 402, the Vendor ID field 320, an Upload Name field 462, a Storage Name field 464, and an Upload Timestamp field 466. In one embodiment, as discussed above, the Account ID field 402 contains text variables storing identification information regarding vendor accounts. The Vendor ID field 320 contains text variables storing-identification information regarding vendors. In one embodiment, the Upload Name field 462 contains the vendor's name for a spreadsheet file that has been uploaded. The Storage Name field 464 contains the name under which the system has saved a spreadsheet file that a vendor has uploaded. While the Upload Timestamp field 466 contains the time at which the vendor uploaded a spreadsheet file.

The Spread Request Table 404 allows vendors to upload spreadsheets containing product offerings available on their websites. For each spreadsheet file that a vendor uploads, one entry is created in the Spread Request table that contains the vendor's name for the file, the name of the file as it was saved on the web server, and the time at which it was uploaded. The table is thus employed as a queue of pending requests by vendors to have their files of product offerings imported into the system. Once a file of offerings has been imported into the system, its entry in the Spread Request table is deleted.

FIG. 3R illustrates a Crawl Request Table 404 which, in one embodiment, comprises the Account ID field 402, the Vendor ID field 320, a Crawl URL field 472. In one embodiment, as discussed above, the Account ID field 402 contains text variables storing identification information regarding vendor accounts. The Vendor ID field 320 contains text variables storing identification information regarding vendors. The Crawl URL field 472 contains text variables storing information regarding the URLs of websites associated with particular vendors.

In general, the Crawl Request Table 470 enables vendors to request the referral computer 120 to periodically browse, or “crawl,” websites associated with the vendors. As discussed above, vendors may desire the referral computer 120 to periodically crawl their websites to obtain current information automatically regarding their products and services, without requiring intervention by the vendors. For example, if Vendor A desired the referral computer 120 to periodically crawl its website (i.e., “www.VendorA.com”), then the Crawl Request Table 470 would include an entry in which the ID for Vendor A's account is stored in the Account ID field 402 and the ID for Vendor A is stored in the Vendor ID field 320. The Crawl URL field for the entry would have a value of “www.VendorA.com”.

FIG. 4 illustrates an example Web page 500 that allows consumers to search for particular products or services in accordance with one embodiment of the invention. In the illustrated embodiment, the Web page 500 comprises a user input box 505, a Price Range selector 510, a plurality of Product Category checkboxes 515, a Product Availability pull-down menu 520, and an information window 525. Those of ordinary skill in the art will understand that the elements of the Web page 500 illustrated in FIG. 4 may be arranged in a wide variety of configurations, and that the Web page 500 may include a wide variety of additional or alternative elements. For example, the information window 525 may be configured to resemble the physical layout of stores in a shopping mail or of aisles in a store.

In one embodiment, the Web page 500 provides a variety of options to consumers for searching the information contained in the vendor product database 200. For example, the consumer may input a search string into the user input box 505 to search the vendor/product database 200 for a particular product or service using keywords. Alternatively, the consumer may search the vendor/product database 200 based on product pricing, on product categorization, or on product availability information by inputting the appropriate criteria into the Price Range selector 510, the Product Category checkboxes 515, or the Product Availability pull-down menu 520, respectively. As another alternative, the consumer may search for a particular product or service in the vendor/product database 200 by browsing through the product category links displayed in the information window 525.

In operation, a consumer searches the vendor/product database 200 for a particular product or service using one of the methods described above or any other suitable method. Once the consumer has identified a particular product or service, as discussed above, the referral computer 120 displays to the consumer a list of offerings from a plurality of on-line vendors that offer the product or service identified by the consumer.

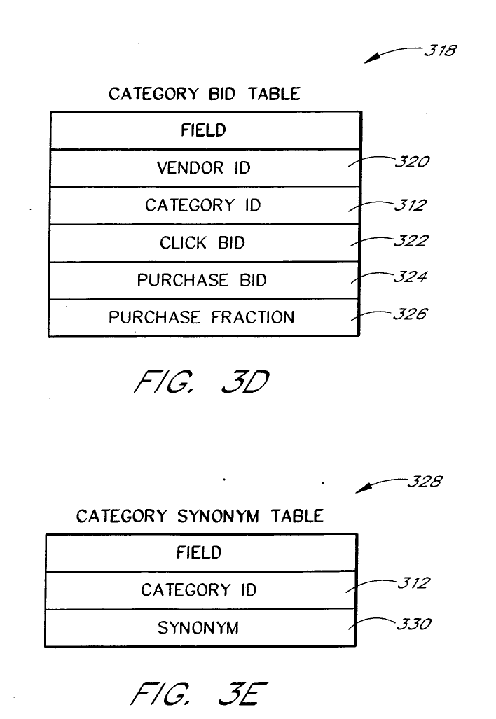

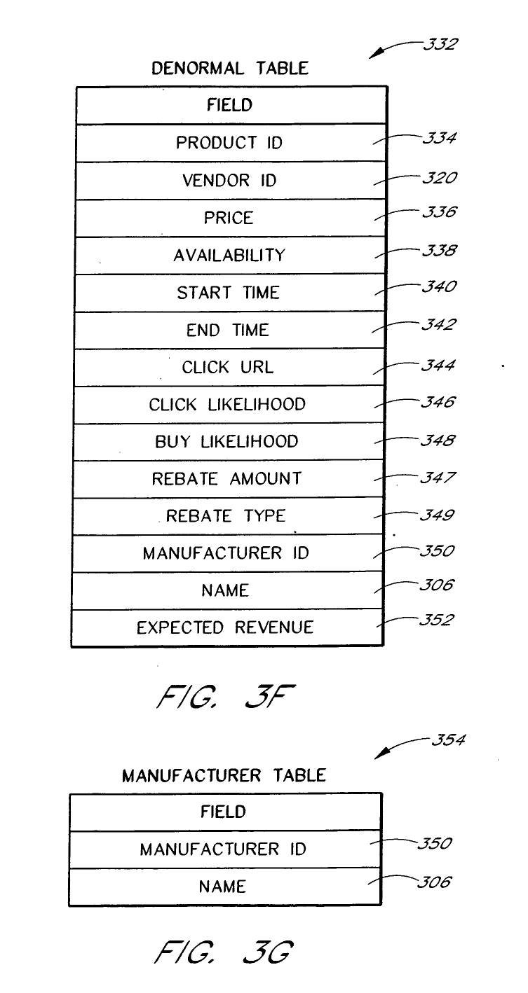

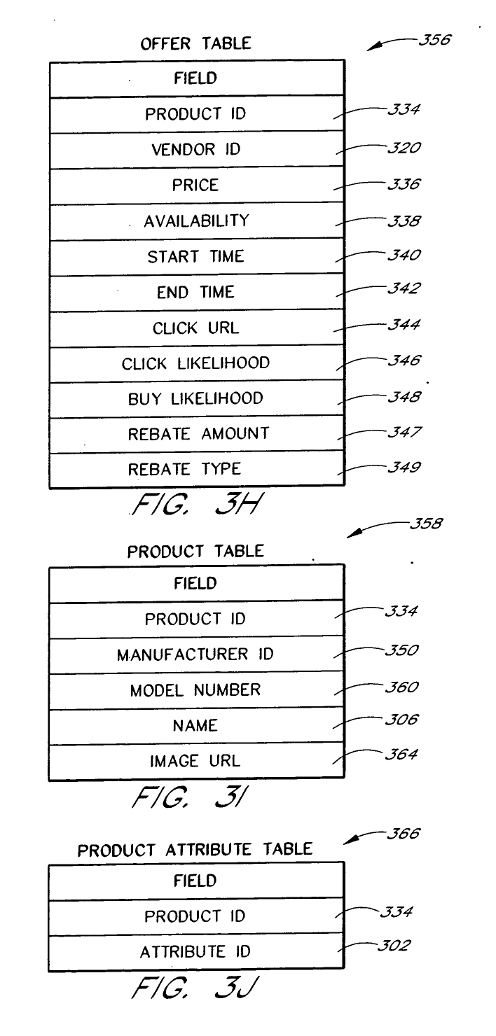

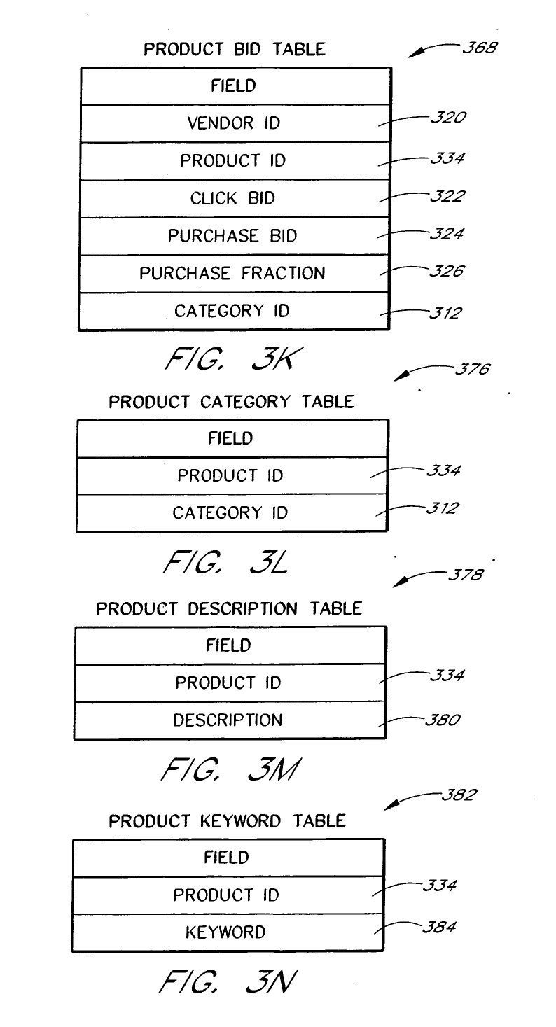

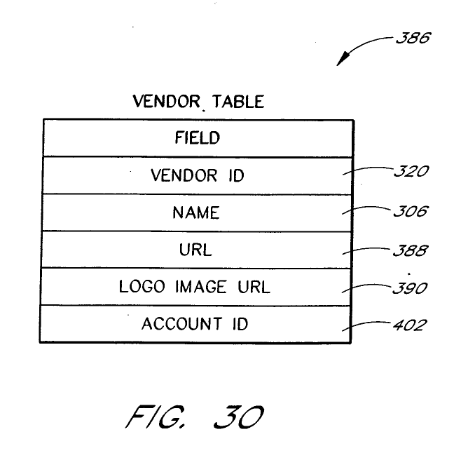

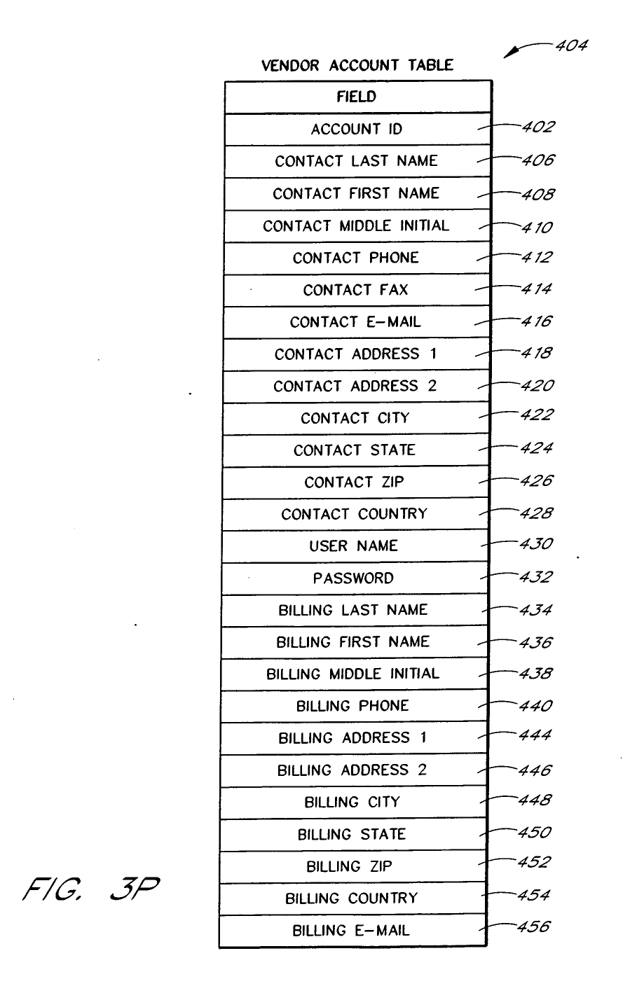

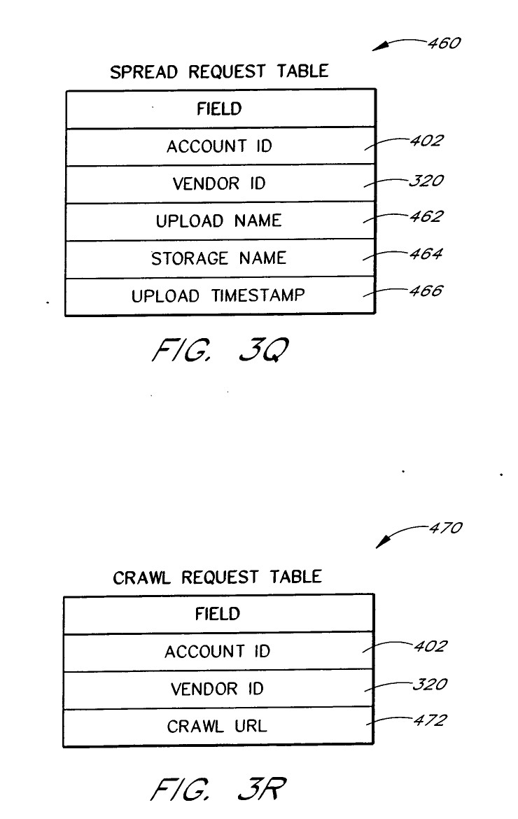

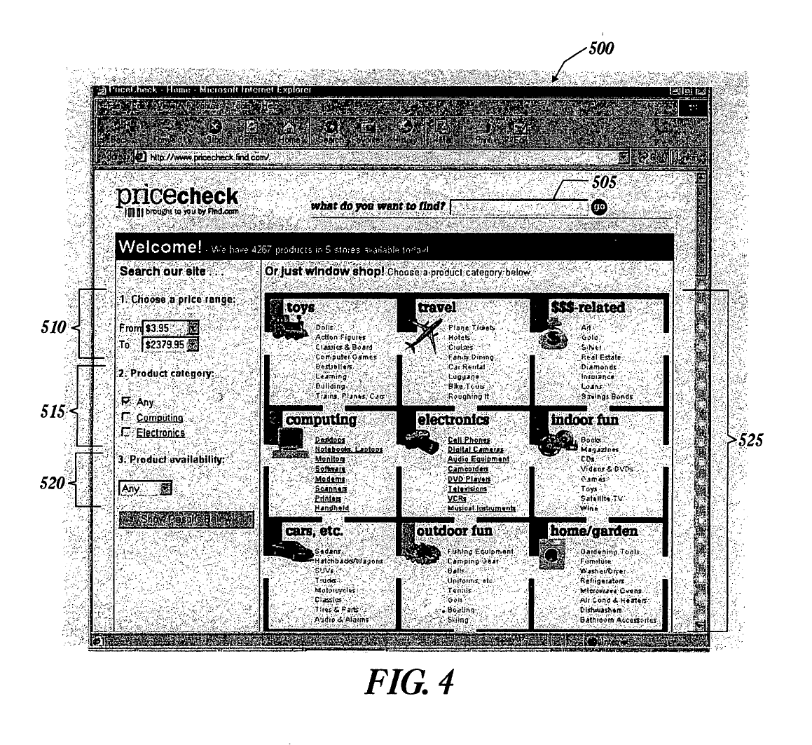

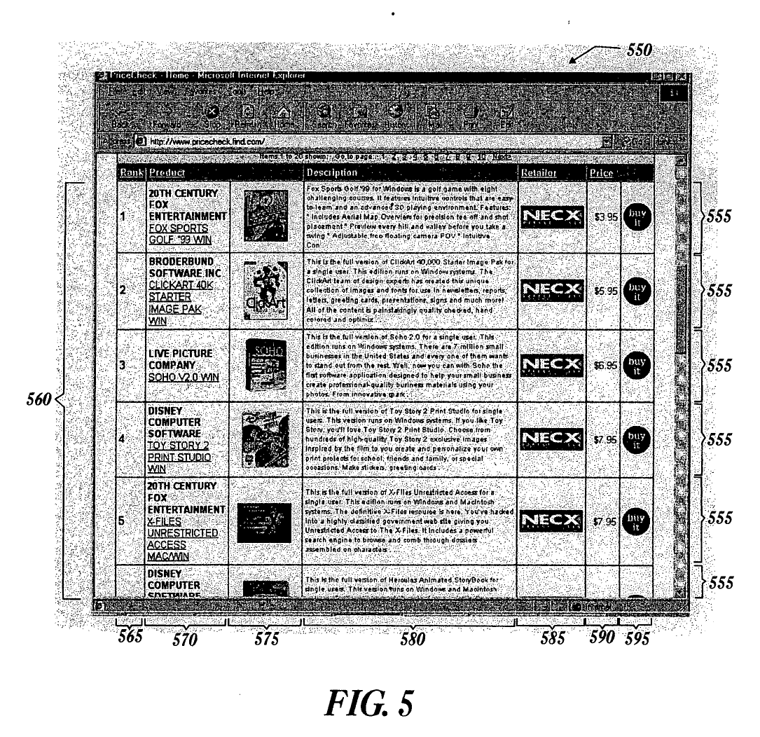

FIG. 5 illustrates an example Web page 550 that displays a list of offerings 555 from on-line vendors in accordance with one embodiment of the invention. In the illustrated embodiment, the offerings 555 are displayed in a table 560 comprising a Rank field 565, a Product field 570, an Image field 575, a Description field 580, a Retailer field 585, a Price field 590, and a Hyperlink field 595. Those of ordinary skill in the art will understand that the elements of the Web page 550 illustrated in FIG. 5 may be arranged in a wide variety of configurations, and that the Web page 550 may include a wide variety of additional or alternative elements. For example, the table 560 may include additional fields, such as a Product Availability field or a Model Number field. Moreover, the offerings 555 may be displayed in an alternative configuration, such as a configuration resembling the physical layout of products on a store shelf.

As discussed above, in one embodiment, the information displayed in the table 560 regarding the offerings 555 is stored in the vendor/product database. 200. For example, the information displayed in the Product field 570 of the table 560 may be stored in the Name field 306 of the Attribute table 300 described above in connection with FIG. 3A. The images displayed in the Image field 575 may be stored on websites addressed by the variables stored in the Image URL field 364 of the Product table 358 described above in connection with FIG. 31. The information displayed in the Description field 580 may be stored in the Value field 308 of the Attribute table 300 described above in connection with FIG. 3A. The vendor logo images displayed in the Retailer field 585 may be stored on websites addressed by the variables stored in the Logo Image URL field 390 of the Vendor table 386 described above in connection with FIG. 30. The information displayed in the Price field 590 may be stored in the Price field 336 of the Denormal table 332 described above in connection with FIG. 3F. The hyperlinks referenced by the images displayed in the Hyperlink field 595 may be stored in the Click URL field of the Denormal table 332 described above in connection with FIG. 3F.

Moreover, as discussed above, the list of offerings 555 is preferably sorted and displayed based on the expected revenue generated by each offering 555, as determined by the ranking module 225. In one embodiment, the expected revenue generated by each offering is stored in the Expected Revenue field 352 of the Denormal table 332 described above in connection with FIG. 3F. Accordingly, a rank value is assigned to each offering 555 by comparing its expected revenue to that of the other offerings 555, and the offerings 555 are ranked accordingly. In one embodiment, the rank value of each offering 555 is displayed in the Rank field 565 of the table 560.

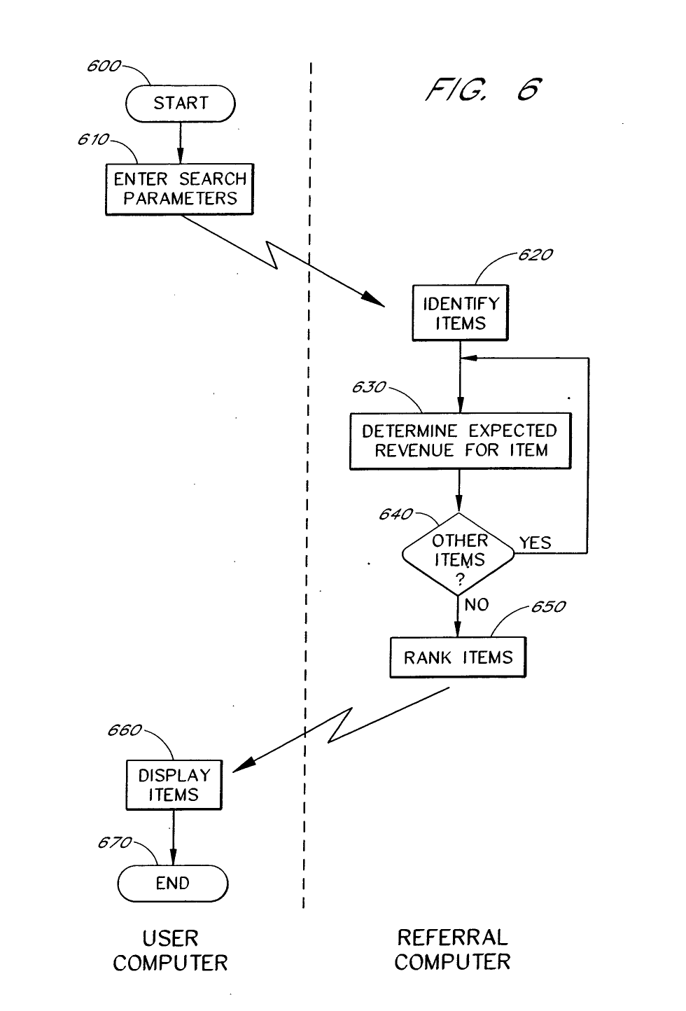

FIG. 6 is a flow chart illustrating a method for ranking of a plurality of items in accordance with one embodiment of the present invention. In a first step 600, the method is started at the user computer 130. In a next step 610, the user enters search parameters into the user computer 130 using the user input box 505, the Price Range selector 510, the Product Category checkboxes 515, the Product Availability pull-down menu 520, or the information window 525 described above in connection with FIG. 4, or using any other suitable method.

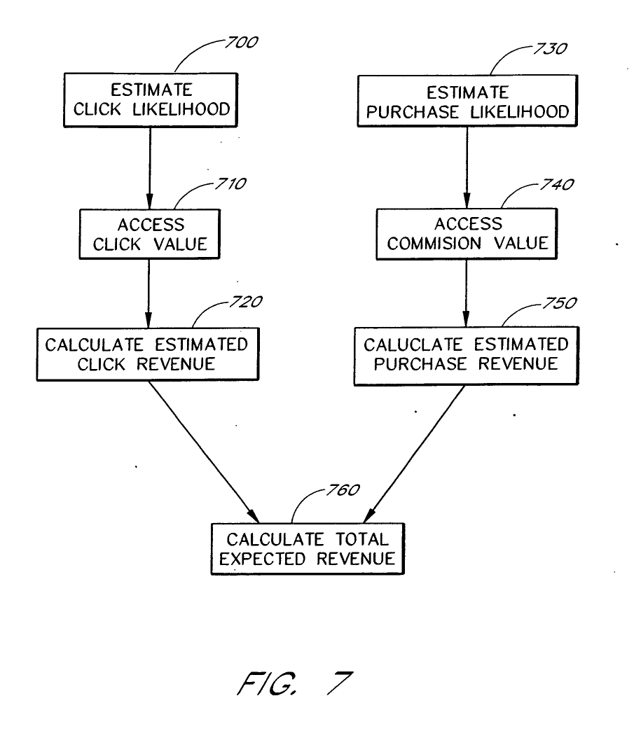

In a step 620, the referral computer 120 identifies the items that match the search parameters entered by the user. In a further step 630, the referral computer 120 determines the expected revenue for one of the items identified during step 620. In one embodiment, as explained in more detail below with respect to FIG. 7, the ranking module 225 of the referral computer 120 calculates the expected revenue for the item using information stored in the vendor/product database 200 and in the history database 215, and stores the expected revenue for the item in the Expected Revenue field 352 of the Denormal Table 332, which is described above in connection with FIG. 3F. Therefore, the determination of the expected revenue of the item during step 630 is made by accessing the Expected Revenue field 352 of the Denormal Table 332.

In a next step 640, the referral computer 120 determines whether there are any remaining items identified during step 620, for which the expected revenue needs to be determined. If so, then the method returns to step 630, where the referral computer 120 determines the expected revenue for the remaining item identified during step 640. Otherwise, the method proceeds to a step 650, where the referral computer 120 ranks all of the items identified during step 620.

In a next step 660, the user computer 130 displays the ranked list of items to the user. As discussed above with respect to FIG. 5, this list may be displayed to the user in a variety of formats, such as, for example, the format of the table 560. Those of ordinary skill in the art will understand, however, that countless other configurations are possible for displaying the list of items to the user. In a final step 670, the method for ranking the plurality of items is ended by the user computer 130.

In one embodiment, as discussed above, the ranked items constitute offerings from a plurality of on-line vendors. The rank of a particular offering determines its position in the list of offerings displayed to the consumer. In general, the offerings are positioned such that consumers are more likely to select the offerings having higher ranks than to select the offerings having lower ranks. Accordingly, by ranking the list of offerings according to the expected revenue derived from each offering, consumers are more likely to select the offerings that will generate the most income for the referral computer administrator. Thus, the income received by the referral computer administrator is advantageously increased.

In general, a first offering with a rank that is greater than a second offering will appear higher in the list of offerings than the second offering. In some embodiments, however, the position of each offering may not correspond exactly with its associated rank. For example, if Offering I is ranked higher than Offering 2 such that Offering 1 appears new the bottom of the first page of offerings, whereas Offering 2 appears at the top of the second page of offerings, then in some embodiments, the positions of Offering I and Offering 2 may be reversed.

FIG. 7 is a flow chart illustrating a method for calculating the expected revenue for a particular item in accordance with one embodiment of the present invention. As discussed above, in one embodiment, the item constitutes an offering from an on-line vendor. Moreover, as discussed above, the ranking module 225 of the referral computer 120 preferably calculates the expected revenue for each item using information stored in the vendor/product database 200 and in the history database 215.

In a step 700, the ranking module 225 estimates the click likelihood of the offering. To perform this step, the ranking module 225 accesses the information stored in the history database 215 to determine the historical selection patterns of past users. As discussed above, this information may be stored in the Click Likelihood field 346 of the Denormal table 332 described above in connection with FIG. 3F. Using this information, the ranking module 225 determines the likelihood that the current user will select the particular offering for which the expected revenue is being calculated.

As discussed above, a variety of factors can be considered when determining the click likelihood for a particular offering. For example, factors such as the period of time during which user history data is being considered and the sample of users whose history is being considered can affect the click likelihood for an offering. Accordingly, these factors can be weighted appropriately to improve the accuracy of the click likelihood determination for a particular offering. For example, recent user history data may be weighted more heavily than old user history data when determining click likelihood. Similarly, user history data regarding consumers with a similar demographic background to the current user may be weighted more heavily than other user history data.

In a step 710, the ranking module 225 accesses the click value of the offering. In one embodiment, the click value of an offering constitutes the amount that a particular vendor will pay to the referral computer administrator in the event that a consumer selects an offering from the vendor. As discussed above, this information may be stored in the Click Bid field 322 of the Category Bid table 318 described above in connection with FIG. 3D.

In a step 720, the ranking module 225 calculates the estimated click revenue for the offering. In one embodiment, the ranking module 225 utilizes the information obtained during steps 700 and 710 to perform this step. For example, if Offering I and Offering 2 have the same click value, but the click likelihood for Offering I is greater than the click likelihood for Offering 2, then the estimated click revenue of Offering 1 would be greater than that of Offering 2.

In one embodiment, the ranking module 225 calculates the estimated click revenue for an offering using the following equation:
Estimated Click Revenue=Click Likelihood×Click Value
Those of ordinary skill in the art will understand, however, that numerous algorithms can be employed to determine the estimated click revenue of an offering using the information stored in the vendor/product database 200 and in the history database 215.

In a step 730, the ranking module 225 estimates the purchase likelihood for the offering. To perform this step, the ranking module 225 accesses the information stored in the history database 215 to determine the historical buying patterns of past users. As discussed above, this information may be stored in the Buy Likelihood field 348 of the Denormal table 332 described above in connection with FIG. 3F. Using this information, the ranking module 225 determines the likelihood that the current user will purchase the product or service offered in the particular offering for which the expected revenue is being calculated.

As discussed above, a variety of factors can be considered when determining the purchase likelihood for a particular offering. For example, factors such as the period of time during which user history data is being considered and the sample of users whose history is being considered can affect the purchase likelihood for an offering. Accordingly, these factors can be weighted appropriately to improve the accuracy of the purchase likelihood determination for a particular offering. For example, recent user history data may be weighted more heavily than old user history data when determining purchase likelihood. Similarly, user history data regarding consumers with a similar demographic background to the current user may be weighted more heavily than other user history data.

In a step 740, the ranking module 225 accesses the commission value for the offering. In one embodiment, the commission value of an offering constitutes the total amount that a particular vendor will pay to the referral computer administrator in the event that a consumer purchases a product or service from the vendor after selecting an offering displayed by the referral computer 120. For example, as discussed above, the referral computer administrator may receive a flat fee from a vendor when a consumer purchases a product or service from the vendor. This information may be stored in the Purchase Bid field 324 of the Category Bid table 318 described above in connection with FIG. 3D. In addition, referral computer administrator may receive a percentage of the purchase price of a product or service from a vendor when a consumer purchases the product or service from the vendor. This information may be derived from the information stored in the Purchase Fraction field 326 of the Category Bid table 318 described above in connection with FIG. 3D and from the information stored in the Price field 336 of the Denormal table 332 described above in connection with FIG. 3F.

In a step 750, the ranking module 225 calculates the estimated purchase revenue for the offering. In one embodiment, the ranking module 225 utilizes the information obtained during steps 730 and 740 to perform this step. For example, if Offering 1 and Offering 2 have the same commission value, but the purchase likelihood for Offering 1 is greater than, the purchase likelihood for Offering 2, then the estimated purchase revenue of Offering 1 would be greater than that of Offering 2.

In one embodiment, the ranking module 225 calculates the estimated purchase revenue for an offering using the following equation:
Estimated Purchase Revenue=Purchase Likelihood×Commission Value
Those of ordinary skill in the art will understand, however, that numerous algorithms can be employed to determine the estimated purchase revenue of an offering using the information stored in the vendor/product database 200 and in the history database 215.

In a step 760, the ranking module 225 calculates the total expected revenue for the offering. In one embodiment, the ranking module 225 utilizes the information obtained during steps 720 and 750 to perform this step. For example, if Offering 1 and Offering 2 have the same estimated click revenue, but the estimated purchase revenue for Offering I is greater than the estimated purchase revenue for Offering 2, then the total expected revenue of Offering I would be greater than that of Offering 2.

In one embodiment the ranking module 225 calculates the. total expected revenue for an offering using the following equation:
Total Expected Revenue=Estimated Click Revenue+Estimated Purchase Revenue
Those of ordinary skill in the art will understand, however, that numerous algorithms can be employed to determine the total expected revenue of an offering using the information stored in the vendor/product database 200 and in the history database 215.

Because the total expected revenue of an offering is based, in part, on the fees that the referral computer administrator receives from a vendor when a consumer selects an offering and ultimately purchases a product or service from the vendor, affiliate vendors can advantageously control, in part, the ranking of their offerings by adjusting the referral and commission fees that they are willing to pay to the referral computer administrator. Accordingly, the referral and commission fees offered to the referral computer administrator by an, affiliate vendor are essentially “bids” for higher ranking, and hence better positioning, in the list of offerings displayed to the consumer.

Affiliate vendors can advantageously control the time period during which their bids remain in effect. For example, if a vendor is having a short-term sale on a particular product, the vendor can temporarily increase its bid on the product to attract consumers during the term of the sale.

Moreover, affiliate vendors can submit bids for categories of products in general, or for particular products specifically. In one embodiment, when a consumer identifies a particular product or service, the ranking module 225 considers the bid submitted by each vendor at the most specific level of categorization applicable to the selected product or service when determining the rank of each offering.

For example, Product 1 and Product 2 are computer games, which are categorized in the general category of Toys, and in the subcategory of Computer Games. Vendor A has submitted a click bid of $0.15 per click in the general category of Toys, but has not submitted a click bid for the subcategory of Computer Games or for Product 1 or Product 2 specifically. Vendor B, on the other hand, has submitted a click bid of $0.05 per click in the general category of Toys and a click bid of $0.10 per click in the subcategory of Computer Games. Moreover, although Vendor B has submitted a click bid of $0.50 per click of its offering for Product 1, it has not submitted a click bid for Product 2.

A first consumer searches the vendor/product database 200 and selects Product 1. As discussed above, to calculate the total expected revenue for Vendor A's offering and for Vendor B's offering of Product 1, the ranking module 225 determines, among other things, the click bids submitted by Vendors A and B for Product 1. Because Vendor A has submitted a click bid of $0.15 per click in the general category of Toys, but has not submitted a click bid for the subcategory of Computer Games or for Product 1 specifically, the ranking module 225 determines that Vendor A's click bid in the general category of Toys is the most specific click bid submitted by Vendor A for Product 1. Therefore, the ranking module 225 determines that the click bid of $0.15 per click is the appropriate click bid to consider for Vendor A. On the other hand, because Vendor B has submitted a click bid of $0.50 per click of the offering for Product I specifically, the ranking module 225 determines that the click bid of $0.50 per click is the appropriate click bid to consider for Vendor B, even though Vendor B has submitted click bids for the general category of Toys for the subcategory of Computer Games. Accordingly, the ranking module 225 determines that the click bid submitted by Vendor B for Product I is greater than the click bid submitted by Vendor A for Product 1.

A second consumer searches the vendor/product database 200 and selects Product 2. As discussed above, to calculate the total expected revenue for Vendor A's offering and for Vendor B's offering of Product 2, the ranking module 225 determines, among other things, the click bids submitted by Vendors A and B for Product 2. For the same reasons discussed above with respect to Product 1, the ranking module 225 determines that the click bid of $0.15 per click in the general category of Toys is the appropriate click bid to consider for Vendor A. Because Vendor B has not submitted a click bid for Product 2 specifically, but has submitted a click bid of $0.10 per click in the subcategory of Computer Games, the ranking module 225 determines that the click bid in the subcategory of Computer Games is the most specific click bid submitted by Vendor A for Product 2, even though Vendor B has submitted a click bid for the general category of Toys. Therefore, the ranking module 225 determines that the click bid of $0.10 per click is the appropriate click bid to consider for Vendor B. Accordingly, the ranking module 225 determines that the click bid submitted by Vendor A for Product 2 is greater than the click bid submitted by Vendor B for Product 2.

As discussed above, the ranking module 225 considers other factors in addition to the click bids submitted by each vendor when calculating the total expected revenue of each offering. In one embodiment, the ranking module 225 also considers the other bids submitted by each vendor, such as, for example, the purchase bids and the purchase fractions submitted by each vendor, at the most specific level of categorization applicable to the selected product or service when determining the rank of each offering. Once the ranking module 225 has determined the appropriate bids to consider for each offering and has accessed the information stored in the history database 215, the ranking module 225 calculates the total expected revenue for each offering and ranks the offerings accordingly.

Although this invention has been disclosed in the context of certain preferred embodiments and examples, it will be understood by those skilled in the art that the present invention extends beyond the specifically disclosed embodiments to other alternative embodiments and/or uses of the invention and obvious modifications and equivalents thereof. Thus, it is intended that the scope of the present invention herein disclosed should not be limited by the particular disclosed embodiments described above, but should be determined only by a fair reading of the claims that follow.

1. A method of operating a ranking website affiliated with a first entity to rank offerings offered by at least one on-line vendor, wherein each offering has associated with it a revenue estimated to be generated for the first entity, the method comprising:
estimating, with the ranking website, a first purchase likelihood that corresponds to the likelihood that a user will click on a link and purchase an item offered in a first offering from an on-line vendor;
calculating, with the ranking website, an estimated first purchase commission revenue using the first purchase likelihood and a commission to be received by the first entity when the user purchases the item offered in the first offering; and
comparing the estimated revenues associated with the offerings and ranking, with the ranking website, the first offering relative to another offering so as to increase income received by the first entity;
wherein the estimated revenue associated with the first offering comprises the first purchase commission revenue.

2. The method of claim 1, further comprising:
estimating, with the ranking website, a second purchase likelihood that corresponds to the likelihood that the user will click on a link and purchase an item offered in a second offering from an on-line vendor; and
calculating, with the ranking website, an estimated second purchase commission revenue using the second purchase likelihood and a commission to be received by the first entity when the user purchases the item offered in the second offering;
wherein the estimated revenue associated with the second offering comprises the second purchase commission revenue.

3. The method of claim 1, wherein the estimated revenue associated with the first offering also includes at least one of (a) a fee to be received by the first entity when the first offering is displayed to a user, and (b) an estimated click revenue calculated using a likelihood that a user will click on a link associated with the first offering and a fee to be received by the first entity when the user clicks on the link.

4. The method of claim 1, wherein the purchase commission comprises at least one of a flat fee and a percentage of the price of a purchased item.

5. The method of claim 1, wherein the purchase likelihood is based on user history data.

6. The method of claim 5, wherein the user history data is weighted by at least one of weighing recent user history data more heavily than older user history data, and weighing user history data regarding users with a similar demographic background to a current user more heavily than other user history data.

7. The method of claim 1, further comprising:
receiving a search parameter entered by a user;
wherein offerings to be ranked link to websites of on-line vendors with offerings matching the search parameter.

8. The method of claim 1I, wherein the ranked offerings that are displayed to the user are displayed in a list.

9. The method of claim 8, wherein the ranked offerings that are displayed to the user have associated with them respective displayed vendor logo images.

10. A system affiliated with a first entity that ranks offerings offered by at least one on-line vendor, wherein each offering has associated with it a revenue estimated to be generated for the first entity, comprising:
a first offering from an on-line vendor;
a second offering from an on-line vendor; and
a ranking module stored in a computer readable storage medium, wherein the ranking module:
estimates a first purchase likelihood that corresponds to the likelihood that a user will click on a hyperlink associated with the first offering and purchase an item offered in the first offering,
calculates an estimated first purchase commission revenue using the first purchase likelihood and a commission to be received by the first entity when the user purchases the item offered in the first offering,
estimates a second purchase likelihood that corresponds to the likelihood that the user will click on a hyperlink associated with the second offering and purchase an item offered in the second offering,
calculates an estimated second purchase commission revenue using the second purchase likelihood and a commission received by the first entity when the user purchases the item offered in the second offering, and
compares the estimated revenues associated with the offerings and ranks the first offering relative to the second offering so as to increase income received by the first entity;
wherein the estimated revenues comprise purchase commission revenues associated with the offerings.

11. The system of claim 10, wherein the estimated revenue associated with each offering also includes at least one of (a) a fee to be received by the first entity when the offering is displayed to a user, and (b) an estimated click revenue calculated using a likelihood that a user will click on the hyperlink associated with the offering and a fee to be received by the first entity when the user clicks on the hyperlink.

12. The system of claim 10, wherein the purchase commission comprises at least one of a flat fee and a percentage of the price of a purchased item.

13. The system of claim 10, wherein the purchase likelihood is based on user history data.

14. The system of claim 13, wherein the user history data is weighted by at least one of weighing recent user history data more heavily than older user history data, and weighing user history data regarding users with a similar demographic background to a current user more heavily than other user history data.

15. The system of claim 10, further comprising:
receiving a search parameter entered by a user;
wherein offerings to be ranked link to websites of on-line vendors with offerings matching the search parameter.

16. The system of claim 10, wherein the ranked offerings that are displayed to the user are displayed in a list.

17. The system of claim 16, wherein the ranked offerings that are displayed to the user have associated with them respective displayed vendor logo images.

18. A system affiliated with a first entity that ranks offerings offered by at least one on-line vendor, wherein each offering has associated with it a revenue estimated to be generated for the first entity, comprising:
a first offering from an on-line vendor;
a second offering from an on-line vendor; and
a ranking module stored in a computer readable storage medium, wherein the ranking module:
estimates a first purchase likelihood that corresponds to the likelihood that a user will click on a hyperlink associated with the first offering and purchase an item offered in the first offering,
calculates an estimated first purchase commission revenue using the first purchase likelihood and a commission to be received by the first entity when the user purchases the item offered in the first offering,
estimates a second purchase likelihood that corresponds to the likelihood that the user will click on a hyperlink associated with the second offering and purchase an item offered in the second offering,
calculates an estimated second purchase commission revenue using the second purchase likelihood and a commission received by the first entity when the user purchases the item offered in the second offering, and
compares the estimated revenues associated with the offerings and ranks the first offering relative to the second offering so as to increase income received by the first entity,
wherein each estimated revenue comprises a purchase commission revenue associated with the offering and an estimated click revenue calculated using a likelihood that a user will click on the hyperlink associated with the offering and a fee to be received by the first entity when the user clicks on the hyperlink.

19. The system of claim 18, wherein the estimated revenue associated with each offering also includes a fee to be received by the first entity when the first offering is displayed to a user an estimated click revenue calculated using a likelihood that a user.

20. The system of claim 18, wherein the purchase commission comprises at least one of a flat fee and a percentage of the price of a purchased item.

21. The system of claim 18, wherein the purchase likelihood is based on user history data.

22. The system of claim 21, wherein the user history data is weighted by at least one of weighing recent user history data more heavily than older user history data, and weighing user history data regarding users with a similar demographic background to a current user more heavily than other user history data.

23. The system of claim 18, further comprising:
receiving a search parameter entered by a user;
wherein offerings to be ranked link to websites of on-line vendors with offerings matching the search parameter.

24. The system of claim 18, wherein the ranked offerings that are displayed to the user are displayed in a list.

25. The system of claim 24, wherein the ranked offerings that are displayed to the user have associated with them respective displayed vendor logo images.
